(19) United States
(12) Patent Application Publication
(10) Pub. No.: US 2018/0035743 A1
(43) Pub. Date: Feb. 8, 2018

(54) SOLE WITH LIGHT-CONDUCTING GROOVE

(71) Applicant: Szu-Hsiang Chen, Taipei (TW)

(72) Inventor: Szu-Hsiang Chen, Taipei (TW)

(21) Appl. No.: 15/619,551

(22) Filed: Jun. 12, 2017

(30) Foreign Application Priority Data
Aug. 8, 2016 (TW) 105211963

(51) Int. Cl. A43B 3/00; F21V 23/00; A43B 3/12; A43B 1/00; A43B 13/14; F21V 23/04; F21S 9/02

(52) U.S. Cl. CPC A43B 3/001; F21V 23/04; F21V 23/004; F21S 9/02; A43B 1/0072; A43B 13/14; A43B 3/128; F21Y 2115/10

(57) ABSTRACT

a sole with a light-conducting groove is disclosed, which comprises a footwear and a sole; wherein the sole includes a light-conducting groove disposed therein and for holding a light emitting device; a light incident surface; and a light irradiating surface; wherein the sole, light-conducting groove, light incident surface, and light irradiating surface allow light to communicate with each other and have light-transmitting and light-conducting characteristics; wherein the light emitting device is an independent, waterproof and portable object, and can be placed at any time or removed from the light-conducting groove, when the light emitting device emits light the light enters from the light incident surface into the sole and then diffuses outwardly to the light irradiating surface around the outer periphery of the sole, thereby emitting light to the outside.

### BACKGROUND OF THE INVENTION

### (1) Field of the Invention

The present invention relates to a sole with a light-conducting groove.

### (2) Description of the Related Art

In a bright environment, because of the light enough, so walking or jogging is not easy to accident, but in the dimly lit environment, may be due to poor line of sight and likely to cause pedestrian accidents, usually occurs in the morning or night. In order to avoid the aforementioned problems, the prior art has developed a series of light-emitting products such as luminescent shoes, luminescent slippers, and luminous bracelets. The purpose is to remind other people to increase the visibility of the user and improve the safety.

In Taiwanese Patent Publication No. M407645, M396633, there is provided a light-emitting shoe which emphasizes that a light-emitting unit can improve safety when used at night but the light-emitting unit is fixed at a specific position and can not be removed, so when an outsole of the light-emitting shoe was worn off, shoelaces was broken, light-emitting device war failure, or electronic parts had poor contact problems, and even users no longer like the shoes, most of the time the shoe will not be used or discarded, so the light-emitting shoes become a one-time consumer products. The invention provides a light-emitting device and a footwear as independent individual objects, both of which can be combined at any time, so the shoe factory can produce all kinds of shoes or slippers for the user to choose, then add the light-emitting device, so that the various styles of shoes can be used freely with the light-emitting device, and no longer become a one-time consumer products.

Moreover, because of the progress of science and technology, luminous visual effects and functionality of the shoes of the Taiwanese Patent Publication No. M407645, M396633 have been unable to meet the needs of today's consumers, for example: light-emitting device can not be wireless control, luminous visual effects are too monotonous, and the product itself can not be multi-functional use. Accordingly, the present invention provides a sole with a light-conducting groove structure designed for a light emitting device which can be placed or removed at any time, and the light-emitting device can use intelligent products, such as smart phones, smart watches or smart wristbands to wireless control, so that the light-emitting unit produce a variety of different lighting modes, and can be charged by a wireless charging module, so that the footwear is used more conveniently.

### SUMMARY OF THE INVENTION

For the above-mentioned problems, the main object of the present invention is to provide a sole with a light-conducting, when a user wears a footwear with the sole, it can remind others to increase attention and reduce the occurrence of accidents and enhance the safety of the user.

The present invention is to provide a sole with a light-conducting groove, comprising; a footwear and a sole; wherein the sole includes a light-conducting groove disposed therein and configured to hold a light emitting device; a light incident surface disposed around the light-conducting groove; and a light irradiating surface disposed around an outer periphery thereof; when the light is irradiated to the light incident surface, the light is transmitted through the sole to the radiating surface; wherein the sole, light-conducting groove, light incident surface, and light irradiating surface allow light to communicate with each other and have light-transmitting and light-conducting characteristics; wherein the light emitting device is an independent, waterproof and portable object, and can be placed at any time or removed from the light-conducting groove, when the light emitting device emits light, the light enters from the light incident surface into the sole and then diffuses outwardly to the light irradiating surface around the outer periphery of the sole, thereby emitting light to the outside.

More preferably, wherein the sole has a light transmittance of 78 to 85% and is made of any of PU, TPR and TPU.

More preferably, wherein the light emitting device comprises: a circuit board having a plurality of LEDs disposed around an outer edge thereof; a control unit coupled to the circuit board for controlling the lighting mode of the LEDs; a switch provided on the circuit hoard for switching on and off the control unit; a rechargeable battery coupled to the circuit board for storing and supplying power; a wireless charging module coupled to the circuit board for receiving energy and charging the rechargeable battery; an upper cover and a lower cover, which are a corresponding upper and lower hard plastic housing for sealing said circuit board, LEDs, control unit, switch, rechargeable battery, and wireless charging module.

More preferably, wherein the control unit includes a wireless remote control unit for wirelessly controlling the lighting mode of the LEDs by a lighting control APP of an external intelligent product.

More preferably, wherein the sole includes a transparent or translucent anti-slip outsole.

More preferably, wherein the footwear is a flip-flop style sandal having the sole, a transparent or translucent covering that covers the sole, and a transparent or translucent foot retaining strap coupled to the sole and covering.

More preferably, wherein the sole includes a plurality of fixing grooves, the covering includes a plurality of holes corresponding to the fixing grooves, and the anti-slip outsole includes a plurality of openings corresponding to the fixing grooves; the foot retaining strap includes a plurality of fastening ends corresponding to the fixing grooves, when the fastening ends penetrate the holes, the fixing groove and the openings, it can be fixed to the sole.

More preferably, wherein the footwear is a sneaker having the sole being glued to a bottom thereof and an insole disposed on the sole.

### BRIEF DESCRIPTION OF DRAWINGS

FIG. 1 is a schematic view of a sole with a light-conducting groove of the present invention;

FIG. 2 is a schematic view showing light being conducted in the sole with the light-conducting groove;

FIG. 3 is an exploded view of the sole with the light-conducting groove applied in a flip-flop style sandal;

FIG. 4 is a partial cross sectional view of the flip-flop style sandal;

FIG. 5 is schematic view of [symbol] for a user to wear;

FIG. 6 is schematic view of the flip-flop style sandal when a light emitting device emits light;

FIG. 7 is an exploded view of the sole with the light-conducting groove applied in a sneaker;

FIG. 8 is a perspective view of the light emitting device.

### DETAILED DESCRIPTION OF THE INVENTION

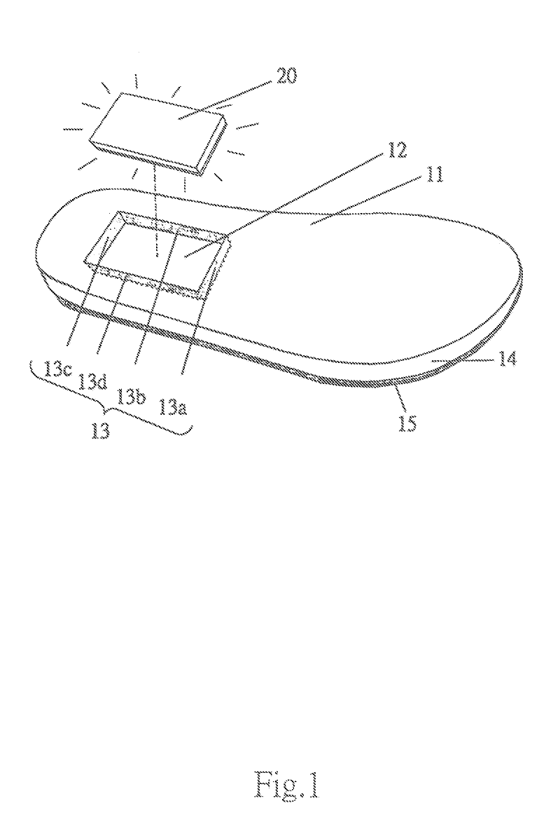

Referring to FIG. 1, the present invention provides to a sole with a light-conducting groove, which is made of a transparent material. The sole (11) comprises a light-conducting groove (12), a light incident surface (13) disposed around the light-conducting groove (12), a light irradiating surface (14) disposed around an outer periphery thereof, and a transparent or translucent anti-slip outsole (15). The light-conducting groove (12) is an accommodating space for being placed or removed by a light emitting device (20).

The sole (11) is made of a light-transmitting PU, TPR, TPU and the like, so that it has excellent light guide, flexibility, and abrasion resistance, the anti-slip outsole (15) is for protecting the sole (11) and also increases the grip to provide an anti-slip function, the sole (11) is bonded to the anti-slip outsole (15) and serves as the bottom of various types of shoes, such as running shoes, sneakers, slippers, etc. The sole (11) and the anti-slip outsole (15) are in the form of a corresponding shape.

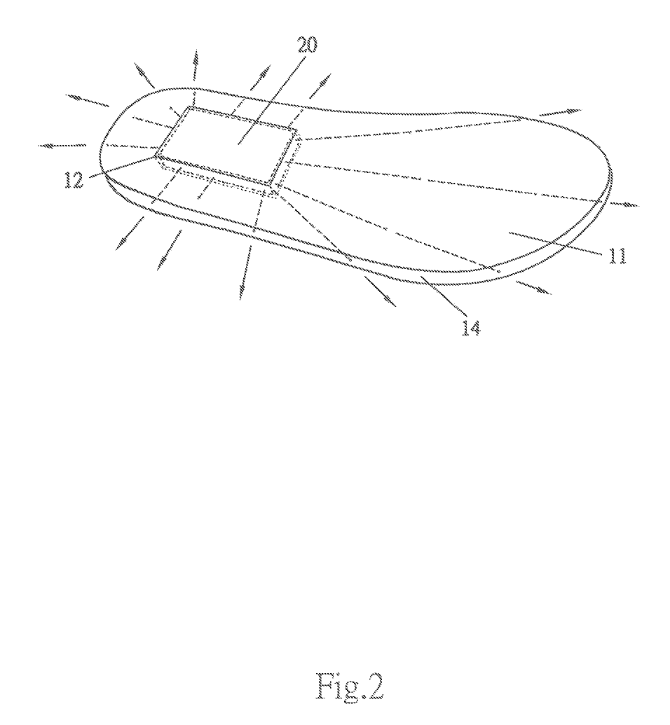

Referring to FIGS. 1-2, the light-conducting groove (12) is of various shape but is preferably rectangular, so that the light emitting device (20) can not be easily displaced or shaken in the light-conducting groove (12); the rectangular light-conducting groove (12) has light incident surface (13) which is transparent and guided in four directions, and is a first incident surface (13a), a second incident surface (13b), a third incident surface (13c), a fourth incident surface (13d), and an upward surface and downward surface are obscured by a user's foot and ground, so the surfaces are not used. When the light emitting device (20) emits light in the light-conducting groove (12), the light enters from the four incident surfaces (13a-13d) and then diffuses into the entire sole (11) and is transmitted to the light irradiating surface (14) through the sole (11), thereby emitting light to the outside.

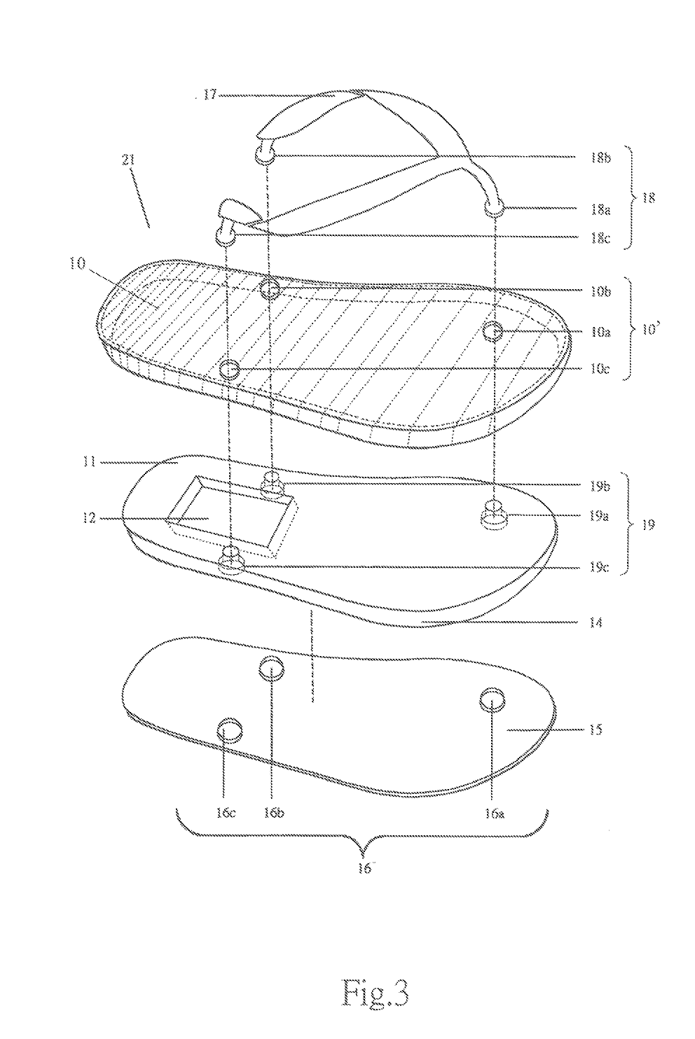

Referring to FIG. 3, the figure discloses a footwear (21) which is a flip-flop style sandal, comprising a sole (11) having a light-conducting groove (12); a transparent or translucent anti-slip outsole (15) correspondingly disposed under the sole (11); a transparent or translucent covering (10) that covers the sole (11); a transparent or translucent foot retaining strap (17) coupled to the sole (11) and covering (10). The sole (11) includes a plurality of fixing grooves (19) for fixing the foot retaining strap (17), the covering (10) includes a plurality of holes (10′) corresponding to the fixing grooves (19), and the anti-slip outsole (15) includes a plurality of openings (16) corresponding to the fixing grooves (19); the foot retaining strap (17) includes a plurality of fastening ends (18) corresponding to the fixing grooves (19) of the sole (11). The fastening ends (18) includes a first fastening end (18a), a second fastening end (18b), and a third fastening end (18c), which are respectively corresponding to a first fixing groove (19a), a second fixing groove (19b), and a third fixing groove (19c) of the fixing grooves (19); a first opening (16a), a second opening (16b), and a third opening (16c) of the openings (16); find a first hole (10a), a second hole (10b), and a third hole (10c) of the holes (10′).

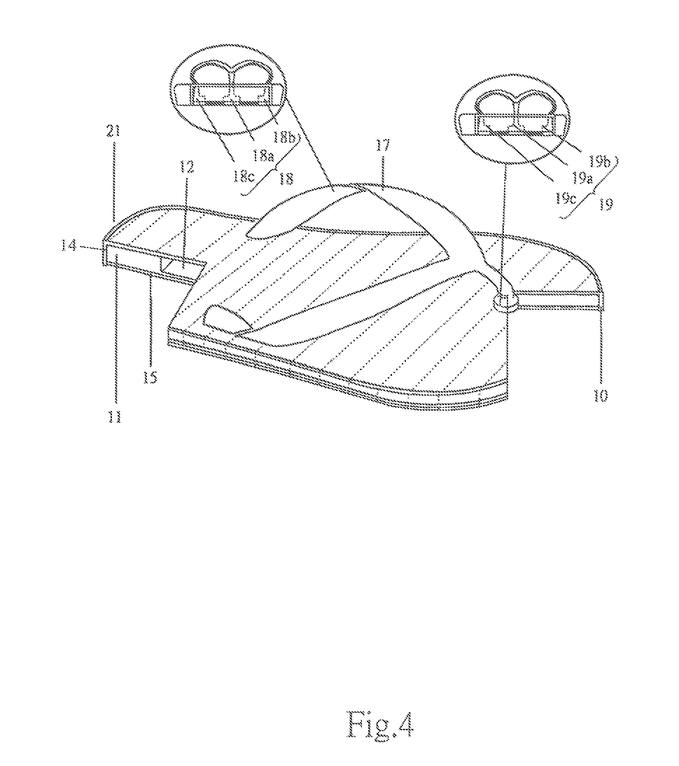

Referring to FIGS. 3-4, the sole (11) is integrally bonded to the anti-slip outsole (15), and the first, second, and third fastening ends (18a, 18b, 18c) of the foot retaining strap (17) correspond to and pass through the first, second, and third holes (10a, 10b, 10c) of the covering (10), the first, second, and third fixing grooves (19a, 19b, 19c) of the sole (11), and the first, second, and third openings (16a, 16b, 16c) of the anti-outsole (15), the covering (10) can be firmly bonded to the sole (11), whereas the covering (10) can be separated from the sole (11).

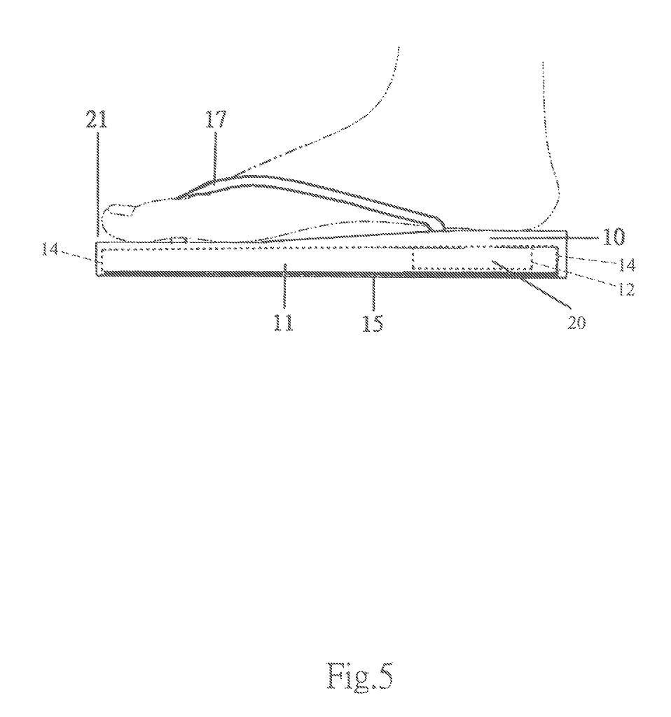

Referring to FIG. 5, there is shown a user wearing the flip-flop style sandal that facilitates the user to replace the covering (10) which simply displaces the covering (10) after pulling the foot fastening end (17) apart. Accordingly, the covering (10) can be designed in a variety of different colors and styles to be selected by the user. In addition, the covering can protect the light emitting device (20) disposed in the light-conducting groove (12) and evenly distribute the heel's weight so that the light-conducting groove (12) is not trampled on, and the foot is prevented from directly touching the light emitting device (20) to take into account the hygienic problem.

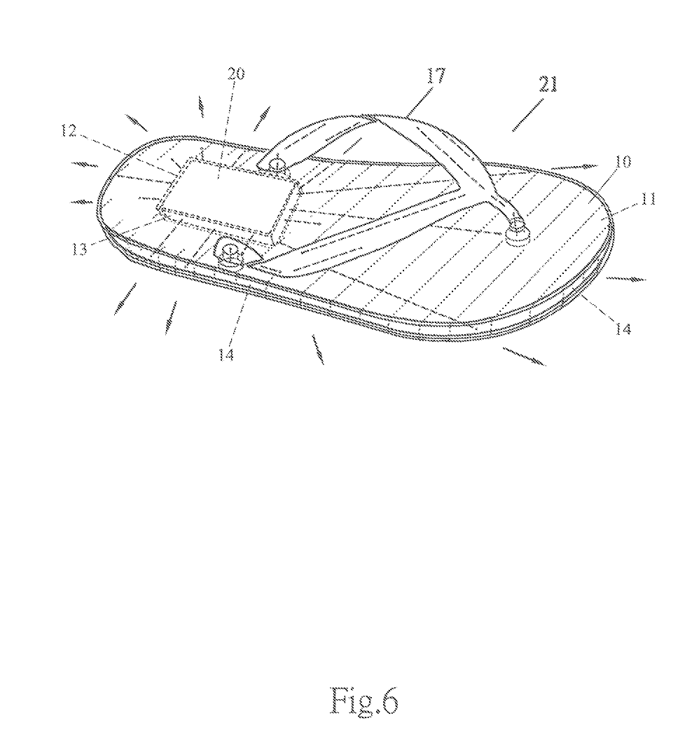

Referring to FIGS. 1, 3, and 6, when the light emitting device (20) is placed in the light-conducting groove (12) and starts to emit light, the light is emitted from the light incident surface (13) into the sole (11) and then transmitted to the light irradiating surface (14) disposed around the outer periphery of the sole (11), and the light is also transmitted into the fastening ends (18) of the foot retaining strap (17) via the fixing grooves (19) and then to the transparent or translucent foot retaining strap (17) so that the light irradiating surface (14) and the foot retaining strap (17) of the dip-flop style sandal emit the light to the outside. Further, the translucent material of the sole (11) has a light transmittance of 78 to 85%, so that it can quickly guide the light to the light irradiating surface (14) to produce bright spots, and does not produce dot-like light emission and weak light between the light spots as the traditional luminescent soles.

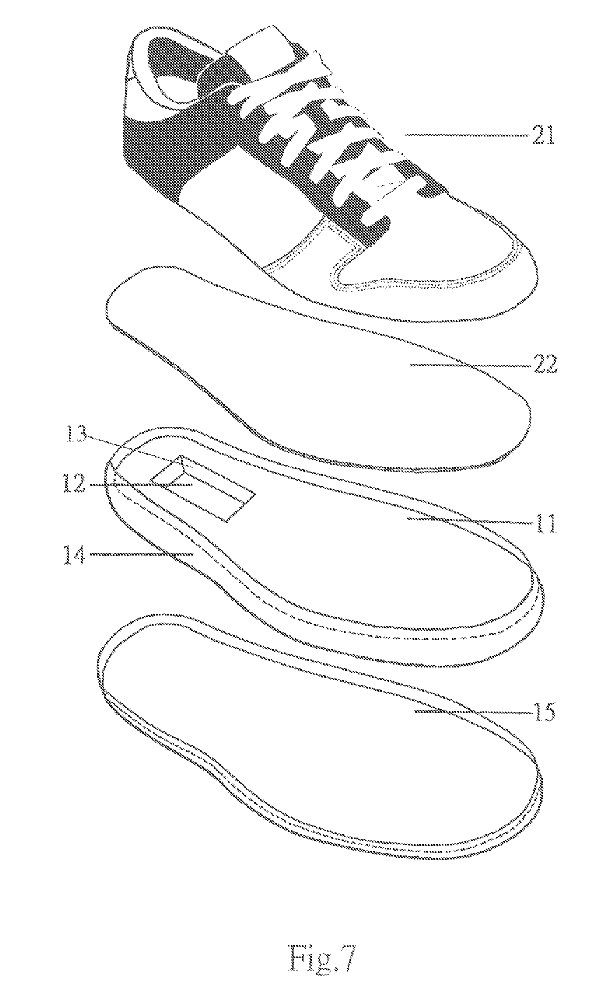

Referring to FIG. 7, the present invention provides another embodiment, the footwear (21) is a sneaker, the sole (11) is integrally bonded to the anti-slip outsole (15) so that the sole (11) is positioned on the lower surface of the sneaker and then the light emitting device (20) is placed in the light-conducting groove (12) of the sole (11), and a corresponding insole (22) is placed on the sole (11) to protect the light emitting device (20) which can be easily placed or removed from the light-conducting groove (12) of the sole (11) and evenly distribute the heel's weight so that the light-conducting groove (12) is not trampled on, and the foot is prevented from directly touching the light emitting device (20) to take into account the hygienic problem.

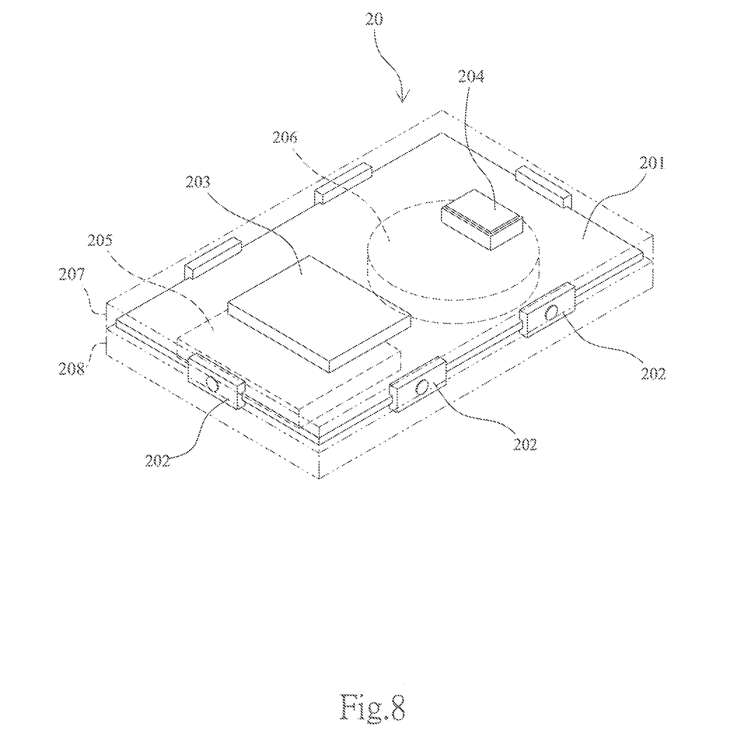

Referring to FIG. 8, the light emitting device (20) comprises a circuit board (201) having a plurality of LEDs (202) disposed around an outer edge thereof; a control unit (203) coupled to the circuit board (201) for controlling the lighting mode of the LEDs; a switch (204) provided on the circuit board (201) for switching on and off the control unit (203); a rechargeable battery (205) coupled to the circuit board (201) for storing and supplying power; a wireless charging module (206) coupled to the circuit board (201) for receiving energy and charging the rechargeable battery (205); an upper cover (207) and a lower cover (208), which are a corresponding upper and lower rigid plastic housing for sealing said circuit board (201) LEDs (202), control unit (203), switch (204), rechargeable battery (205), and wireless charging module (206).

The control unit (203) can control the opening and closing of the LEDs (202), for example, the rotation mode, the brightness, the frequency, the color, the chroma, and the like. Secondly, the control unit (203) further includes a wireless remote control unit, which is a Bluetooth wireless transceiver capable of wirelessly remoteizing with intelligent products, such as smartphones, smart watches, and smart wristbands. In other words, the control unit (203) is wirelessly controlled by light control APP software of the intelligent products to control the lighting mode of the LEDs (202).

The switch (204) is electrically connected to the control unit (203), and the power source of the circuit board (201) can be started or closed via the switch (204), and the switch (204) can be implemented as a touch switch. The wireless charging module (206) is capable of charging the rechargeable battery (205) with the received electric energy in a wireless charging manner. The rechargeable battery (205) of the present invention using a high safety FPC Lithium Ceramic Battery (FLCB) is preferred.

The upper and lower covers (207, 208) are integrally molded housing, which are combined and sealed by high frequency welding to achieve the waterproof effect. As the upper and lower covers (207, 208) is a hard plastic, it can withstand the pressure to achieve anti-pressure and anti-collision effect.

The above only describes some exemplary embodiments of the present invention. Those having ordinary skills in the art may also make many modifications and improvements without departing from the conception of the invention, which shall all fall within the protection scope of the invention.

I claim

1. A sole with a light-conducting groove, comprising:
a footwear (21) and a sole (11);
wherein the sole (11) includes a light-conducting groove (12) disposed therein and configured to hold a light emitting device (20); a light incident surface (13) disposed around the light-conducting groove (12); and a light irradiating surface (14) disposed around an outer periphery thereof; when the light is irradiated to the light incident surface (13), the light is transmitted through the sole (11) to the radiating surface (14);
wherein the sole (11), light-conducting groove (12), light incident surface (13), and light irradiating surface (14) allow light to communicate with each other and have light-transmitting and light-conducting characteristics;
wherein the light emitting device (20) is an independent, waterproof and portable object, and can be placed at any time or removed from the light-conducting groove (12), when the light emitting device (20) emits light, the light enters from the light incident surface (13) into the sole (11) and then diffuses outwardly to the light irradiating surface (14) around the outer periphery of the sole (11), thereby emitting light to the outside.

2. The sole with the light-conducting groove according to claim 1, wherein the sole (11) has a light transmittance of 78 to 85% and is made of any of PU, TPR and TPU.

3. The sole with the light-conducting groove according to claim 1, wherein the light emitting device (20) comprises;
a circuit board (201) having a plurality of LEDs (202) disposed around an outer edge thereof;
a control unit (203) coupled to the circuit board (201) for controlling the lighting mode of the LEDs;
a switch (204) provided on the circuit board (201) for switching on and off the control unit (203);
a rechargeable battery (205) coupled, to the circuit board (201) for storing and supplying power;
a wireless charging module (206) coupled to the circuit board (201) for receiving energy and charging the rechargeable battery (205);
an upper cover (207) and a lower cover (208), which are a corresponding upper and lower hard plastic housing for sealing said circuit board (201), LEDs (202), control unit (203), switch (204), rechargeable battery (205), and wireless charging module (206).

4. The sole with the light-conducting groove according to claim 3, wherein the control unit (203) includes a wireless remote control unit for wirelessly controlling the lighting mode of the LEDs (202) by a lighting control APP of an external intelligent product

5. The sole with the light-conducting groove according to claim 1, wherein the sole (11) includes a transparent or translucent anti-slip outsole (15).

6. The sole with the light-conducting groove according to claim 5, wherein the footwear (21) is a flip-flop style sandal having the sole (11), a transparent or translucent covering (10) that covers the sole (11), and a transparent or translucent foot retaining strap (17) coupled to the sole (11) and covering (10).

7. The sole with the light-conducting groove according to claim 6, wherein the sole (11) includes a plurality of fixing grooves (19), the covering (10) includes a plurality of holes (10′) corresponding to the fixing grooves (19), and the anti-slip outsole (15) includes a plurality of openings (16) corresponding to the fixing grooves (19); the foot retaining strap (17) includes a plurality of fastening ends (18) corresponding to the fixing grooves (19), when the fastening ends (18) penetrate the holes (10′), the fixing groove (19) and the openings (16), it can be fixed to the sole (11).

8. The sole with the light-conducting groove according to claim 5, wherein the footwear is a sneaker having the sole (11) being glued to a bottom thereof and an insole (22) disposed on the sole (11).
